(19) United States
(12) Patent Application Publication
(10) Pub. No.: US 2007/0033610 A1
(43) Pub. Date: Feb. 8, 2007

(54) Signal processing apparatus and method thereof

(75) Inventors: Jin-hee Sohn, Seoul (KR); Young-sil Lim, Cheongju-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/476,105

(22) Filed: Jun. 28, 2006

(30) Foreign Application Priority Data
Aug. 8, 2005 (KR) 2005-0072434

(51) Int. Cl. H04N 7/173; H04N 7/16

(52) U.S. Cl. 725/28; 725/25; 725/100; 725/131

(57) ABSTRACT

A broadcasting signal receiving apparatus and method which receives broadcasting program information and rating level information of broadcasting programs. The apparatus having a user input part in which a setting of a target rating level is input; a UI generator which generates a broadcasting program information table; and a controller which detects a target program distinctively displayed corresponding to the target rating level among the broadcasting programs based on the rating level information and controls the UI generator to display information on the detected target program with a different color from that of information on remaining broadcasting programs among the broadcasting programs on the broadcasting program information table. Thus, a user can check a view-limited program according to a rating level through a broadcasting program information table more clearly.

### CROSS-REFERENCE TO RELATED APPLICATIONS

This application claims priority from Korean Patent Application No. 2005-0072434, filed on Aug. 8, 2005, in the Korean Intellectual Property Office, the disclosure of which is incorporated herein by reference.

### BACKGROUND OF THE INVENTION

1. Field of the Invention

The present invention relates to a broadcasting signal receiving apparatus and a control method thereof, and more particularly, to a broadcasting signal receiving apparatus in which a user checks a view-limited program according to a rating level, and a control method thereof.

2. Description of the Related Art

Generally, terrestrial, cable and satellite broadcastings transmit additional information together with an image signal and an audio signal. The additional information of a transmitted broadcasting program may comprise rating level information.

Meanwhile, a TV may support a view-limiting function through the rating level information which is transmitted with a broadcasting signal. A conventional TV which supports the view-limiting function of TV programs provides a user with a picture to set a view limit rating level and performs the view-limiting function of the TV programs transmitted on the basis of the view limit rating level set by a user. Generally, such a function is performed by a V (violence)-chip which is installed in the TV.

Recently, a TV program rating system set by EIA-766 standards, and an MPAA rating system for movies set by the Motion Picture Association of America (MPAA) are being widely used as the rating level information.

Generally, a rating system can be classified into two types. The first rating system determines the rating level of the TV programs based on viewers' age, and the second one determines the rating level based on the TV program contents such as violence, sex and language. The two rating systems by EIA-766 standards and MPAA classify the rating level based on viewers' age.

Meanwhile, a broadcasting signal receiving apparatus such as a TV or a set-top box provides broadcasting programs and additional information to a user based on information on the TV programs supplied by a broadcasting operator, and additional information such as the rating level.

FIG. 1 illustrates a broadcasting program information table IT' which is supplied by a conventional broadcasting signal receiving apparatus. As shown therein, the broadcasting signal receiving apparatus provides broadcasting programs by channel and time, and additional information on the corresponding broadcasting programs through the broadcasting program information table IT' to ensure a user's convenience.

However, the conventional broadcasting signal receiving apparatus does not provide the rating level information of broadcasting programs clearly and distinctively through the broadcasting program information table IT'.

Further, when the conventional broadcasting signal receiving apparatus provides the rating level as a simple text, a user may hardly recognize the rating level of the broadcasting programs through the broadcasting program information table IT'.

### SUMMARY OF THE INVENTION

Accordingly, it is an aspect of the present invention to provide a broadcasting signal receiving apparatus, which allows a user to check a view-limited program according to a rating level through a broadcasting program information table more clearly, and a control method thereof.

Further, it is another aspect of the present invention to provide a broadcasting signal receiving apparatus, which distinctively displays a view-limited program in consideration with age ranges of viewers, and a control method thereof.

Additional aspects and/or advantages of the present invention will be set forth in part in the description which follows and, in part, will be obvious from the description, or may be learned by practice of the present invention.

The foregoing and/or other aspects of the present invention are also achieved by providing a broadcasting signal receiving apparatus which receives broadcasting program information and rating level information of broadcasting programs, comprising a user input part in which a setting of a target rating level is input; a user interface (UI) generator which generates a broadcasting program information table; and a controller which detects a target program distinctively displayed corresponding to the target rating level among the broadcasting programs based on the rating level information and controls the UI generator to display information on the detected target program with a different color from that of information on remaining broadcasting programs among the broadcasting programs on the broadcasting program information table.

According to another aspect of the present invention, the UI generator generates a rating level setting picture to select at least one of a plurality of rating levels, and the controller sets at least one rating level selected by the user input part among the plurality of rating levels displayed on the rating level setting picture, as the target rating level.

According to another aspect of the present invention, the controller sets the rating level selected from the rating level setting picture and a view-limited rating level according to the selected rating level among the plurality of rating levels, as the target rating level.

According to another aspect of the present invention, the broadcasting program information table comprises at least one first broadcasting program information block which has a first background color and displays information on the detected target program, and at least one second broadcasting program information block which has a second background color different from the first background color, and displays information on the remaining broadcasting programs.

According to another aspect of the present invention, the controller controls the UI generator to arrange the first broadcasting program information block and the second broadcasting program information block based on time and/or channel of the broadcasting program.

According to another aspect of the present invention, the rating level information is included in at least one of moving picture experts group (MPEG) user data, a program map table (PMT), an event information table (EIT), an aggregate event information table (AEIT), and vertical blanking interval (VBI) data, to be transmitted.

The foregoing and/or other aspects of the present invention are also achieved by providing a method of controlling a broadcasting signal receiving apparatus, comprising setting a target rating level; detecting broadcasting program information and rating level information of broadcasting programs; detecting a target program which is distinctively displayed corresponding to the target rating level among the detected broadcasting programs based on the rating level information; and displaying a broadcasting program information table on which information on the detected target program is displayed with a different color from that of information on remaining broadcasting programs among the detected broadcasting programs.

According to another aspect of the present invention, the setting the target rating level comprises displaying a rating level setting picture to select one of a plurality of rating levels; selecting one of the plurality of rating levels displayed on the rating level setting picture; and setting the selected rating level and a view-limited rating level according to the selected rating level among the plurality of rating levels, as the target rating level.

According to another aspect of the present invention, the broadcasting program information table comprises at least one first broadcasting program information block which has a first background color, and displays the information on the detected target program; and at least one second broadcasting program information block which has a second background color different from the first background color, and displays the information on remaining broadcasting programs.

According to another aspect of the present invention, the method further comprises arranging the first broadcasting program information block and the second broadcasting program information block based on time and/or channel of the broadcasting programs.

According to another aspect of the present invention, the rating level information is included in at least one of moving picture experts group (MPEG) user data, a program map table (PMT), an event information table (EIT), an aggregate event information table (AEIT) and vertical blanking interval (VBI) data, to be transmitted.

### BRIEF DESCRIPTION OF THE DRAWINGS

The above and/or other aspects and advantages of the present invention will become apparent and more readily appreciated from the following description of the non-limiting embodiments, taken in conjunction with the accompanying drawings of which:

FIG. 1 illustrates a broadcasting program information table which is supplied by a conventional broadcasting signal receiving apparatus;

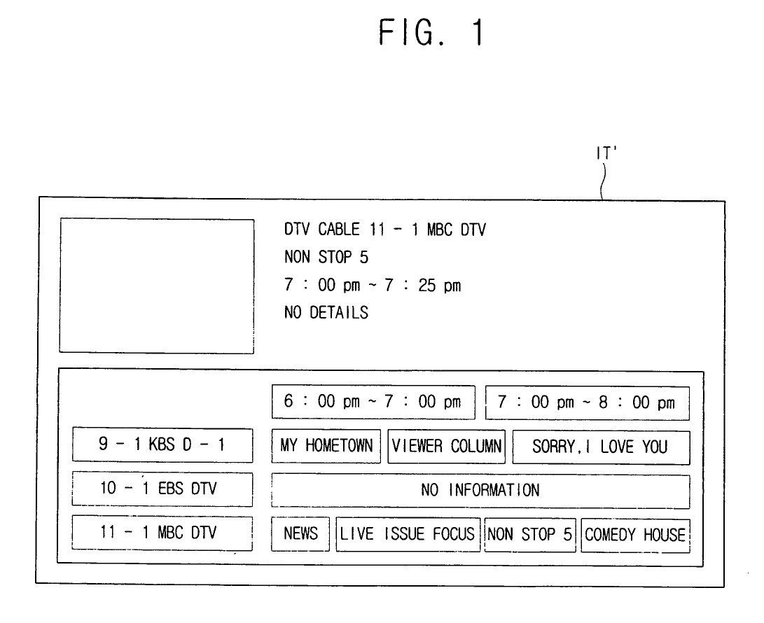

FIG. 2 is a control block diagram of a broadcasting signal receiving apparatus according to the present invention;

FIG. 3 illustrates an example of a broadcasting program information table, which is supplied by the broadcasting signal receiving apparatus in FIG. 2;

FIG. 4 illustrates an example of a rating level setting picture which is supplied by the broadcasting signal receiving apparatus in FIG. 2; and

FIG. 5 is a control flowchart of the broadcasting signal receiving apparatus according to the present invention.

### DETAILED DESCRIPTION OF EXEMPLARY EMBODIMENTS OF THE INVENTION

Reference will now be made in detail to the non-limiting embodiments of the present invention, examples of which are illustrated in the accompanying drawings, wherein like reference numerals refer to like elements throughout.

In the present embodiment, a broadcasting signal which is transmitted to a broadcasting signal receiving apparatus adopts Advanced Television Systems Committee (ATSC) standards. In the present embodiment, a digital TV is provided as an example of the broadcasting signal receiving apparatus.

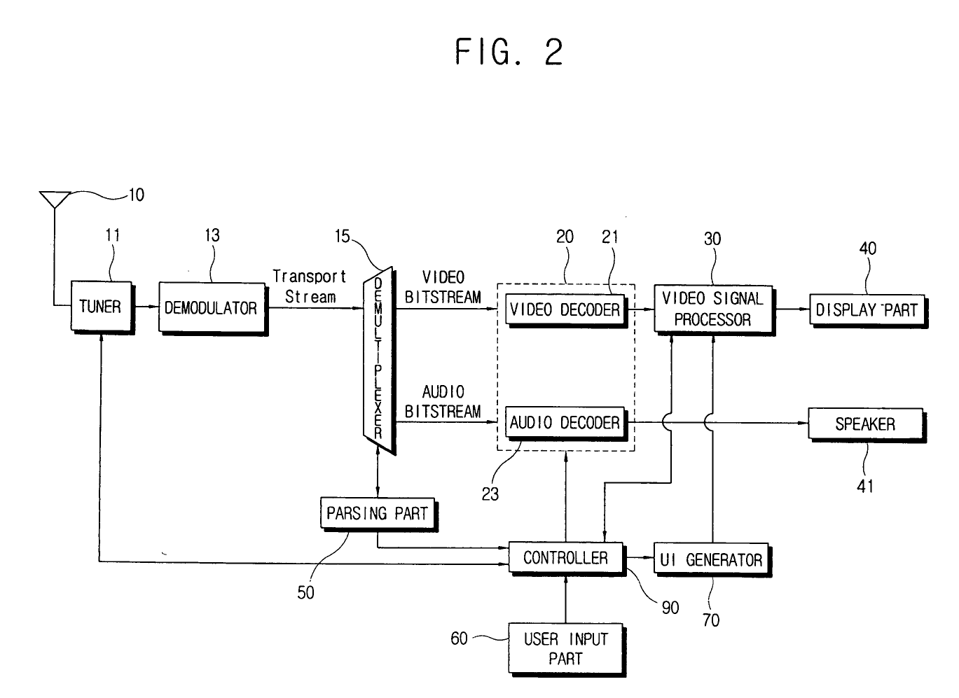

As shown in FIG. 2, a digital TV according to the present invention comprises a user input part 60, a user interface (UI) generator 70 and a controller 90. The digital TV according to the present invention may further comprise an antenna 10, a tuner 11, a demodulator 13, a reverse multiplexer 15 (demultiplexer), a decoder 20, a video signal processor 30, a display part 40, a speaker 41, a parsing part 50 and a memory (not shown).

The tuner 11 tunes the broadcasting signal received through the antenna 10 into a broadcasting signal with a frequency bandwidth corresponding to a tuning control signal of the controller 90. Here, a digital broadcasting signal is transmitted as a transport stream for which a video signal, an audio signal and various data are time-division multiplexed and packetized.

The broadcasting signal of a certain channel which is tuned by the tuner 11 is demodulated and corrected by the demodulator 13 to be output as the transport stream. Then, the broadcasting signal is divided into a video stream, an audio stream and a data stream by the reverse multiplexer 15 to be output as a bit stream.

The video stream, which is divided by the reverse multiplexer 15 is decoded by an MPEG decoder as a video decoder 21 to be processed by the video image signal processor 30 and to be displayed on the display part 40.

The display part 40 may comprise various display modules including a digital light processing (DLP), a liquid crystal display (LCD) and a plasma display panel (PDP). The video signal processor 30 may comprise a scaler, which converts the video stream for satisfying output standards such as a vertical frequency, resolution and a picture ratio of the display part 40.

The audio stream, which is divided by the reverse multiplexer 15 is decoded by an audio decoder 23 to be output to the speaker 41.

Meanwhile, the various data streams, which are divided by the reverse multiplexer 15 are parsed by the parsing part 50 to be stored in a predetermined memory (not shown) by data table.

The transmitted data stream comprises guide information and service information of the broadcasting program. The ATSC standards define a program and system information protocol (PSIP) for service information such as classification of information transmitted to a corresponding transmission channel and a program guide. In the ATSC standards, channels may be classified without program specific information (PSI) standards as a part of MPEG-2 system standards, and PSI is transmitted to be compatible with MPEG-2 even if it is not necessary.

At this time, broadcasting program guide information stored in the memory (not shown) is processed with a currently-tuned video signal through the video signal processor 30 according to a control of the controller 90 (to be described later), to be displayed on the display part 40. Thus, a user may recognize the broadcasting program information (ex. EPG information).

Meanwhile, the parsing part 50 parses rating level information included in additional data to be stored in a memory (not shown). Here, the rating level information may be checked through user information of MPEG-2, a program map table (PMT) of PSI, a master guide table (MGT) of PSIP and a content advisory descriptor having a value on the rating level defined in a rating region table (RRT) of an event information table (EIT).

In a cable broadcasting, the additional information is included in MPEG-2 user data, PMT or an aggregate event information table (AEIT). In an analog broadcasting, the additional information is included in a vertical blanking interval (VBI) to be transmitted.

The digital TV according to a non-limiting embodiment of the present invention stores an internal channel list and broadcasting program information of a corresponding channel. The digital TV according to the non-limiting embodiment of the present invention may store the rating level information of the channel parsed by the parsing part 50, together with the internal channel list and the broadcasting program information of the corresponding channel. For example, in the cable broadcasting, if the AEIT is included in an open cable OOB SI, the rating level information is renewed with respect to the internal channel list and the broadcasting program of the corresponding channel based on the AEIT information. If the AEIT information is not included therein, a tuner 11 other than the tuner 11 currently tuning the channel is used to search channels and to renew the rating level information of the corresponding channel with respect to the internal channel list and the broadcasting program of the corresponding channel.

The user input part 60 is input with a predetermined key signal according to a user's manipulation. The user input part 60 according to the present invention is provided as a wireless remote control as an example. Here, a user sets a target rating level (to be described later) through the user input part 60. The target rating level will be described in detail later.

The UI generator 70 generates a broadcasting program information table IT according to a control of the controller 90 (to be described later). The broadcasting program information table IT generated by the UI generator 70 is synthesized with the video signal currently processed through the video signal processor 30 to be displayed on the display part 40. The UI generator 70 according to the present invention is shown and described as an additional element, separate from the video signal processor 30. Alternatively, the UI generator 70 according to the present invention may be provided as a chip together with the video signal processor 30 such as a scaler.

The controller 90 detects the rating level information among the parsed data stream through the parsing part 50. Also, the controller 90 detects a target program which is distinctively displayed corresponding to the target rating level set through the user input part 60 among the broadcasting programs based on the detected rating level information.

Here, the controller 90 controls the UI generator 70 to display the information on the detected target program with a different color from that of the information on the remaining broadcasting programs on the broadcasting program information table IT. Accordingly, a user may check the view-limited program according to the rating level on the broadcasting program information table IT displayed on the display part 40 more clearly.

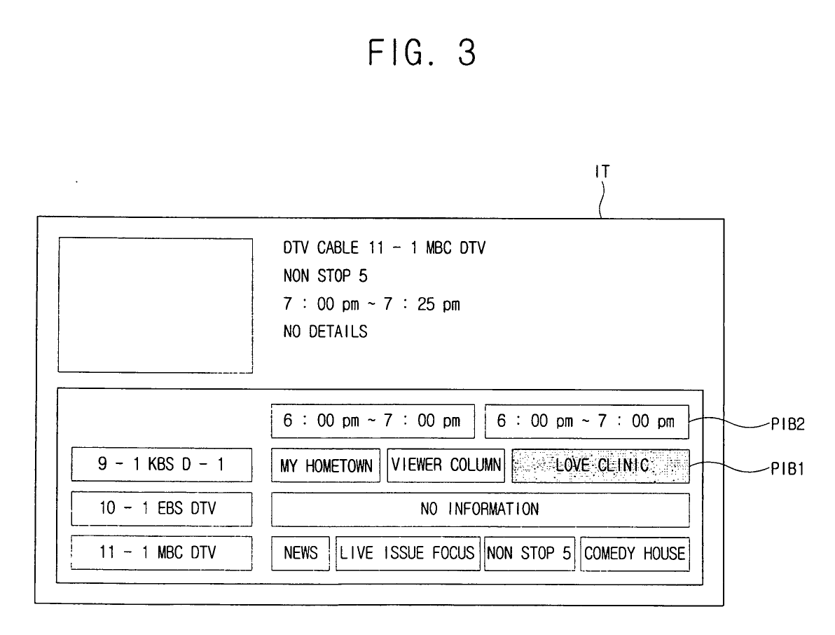

FIG. 3 illustrates an example of the broadcasting program information table IT supplied by the broadcasting signal receiving apparatus according to the present invention. As shown therein, the broadcasting program information table IT may comprise at least one first broadcasting program information block PIB1 which displays information on the target program distinctively displayed; and at least one second broadcasting program information block PIB2 which displays information on the remaining broadcasting programs other than the target program among the broadcasting programs.

Here, the controller 90 controls the first and second broadcasting program information blocks PIB1 and PIB2 to be displayed with different colors, thereby distinguishing the target program according to the set target rating level from other broadcasting programs.

As shown in FIG. 3, the controller 90 controls the UI generator 70 to arrange the first broadcasting program information block PIB1 and the second broadcasting program information block PIB2 according to time and/or channel of the broadcasting programs, as an example of the present invention.

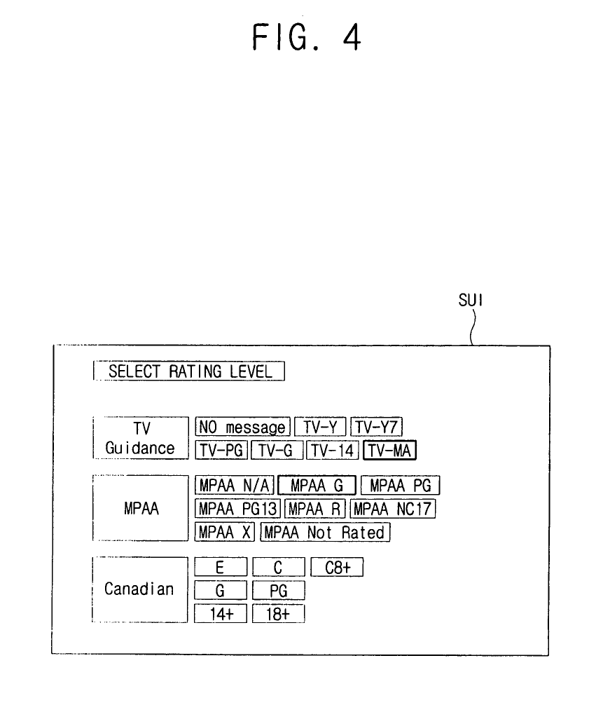

As shown in FIG. 4, the UI generator 70 according to the present invention may generate a rating level setting picture SUI to select one of a plurality of rating levels. FIG. 4 illustrates MPAA rating levels set for movies by the Motion Picture Association of America (MPAA) and rating levels for TV programs set by EIA-766 standards as an example of the present invention. FIG. 4 illustrates an example of the rating level setting picture SUI, but not limited thereto. The rating level setting picture SUI may be provided in various designs.

Here, a user may select one or plural rating levels among the ratings levels displayed on the rating level setting picture SUI by manipulating a direction key of the user input part 60. The controller 90 sets the rating level selected by a manipulation of the user input part 60 and the view-limited rating level according to the selected rating level, as the target rating level. For example, when TV-G is selected from the rating levels of the EIA-766 standards, i.e., TV-Y, TV-Y7, TV-G, TV-PG, TV-14 and TV-MA, the selected TV-G and the superior rating levels of the TV-G, i.e., TV-PG, TV-14 and TV-MA are set as the target rating level.

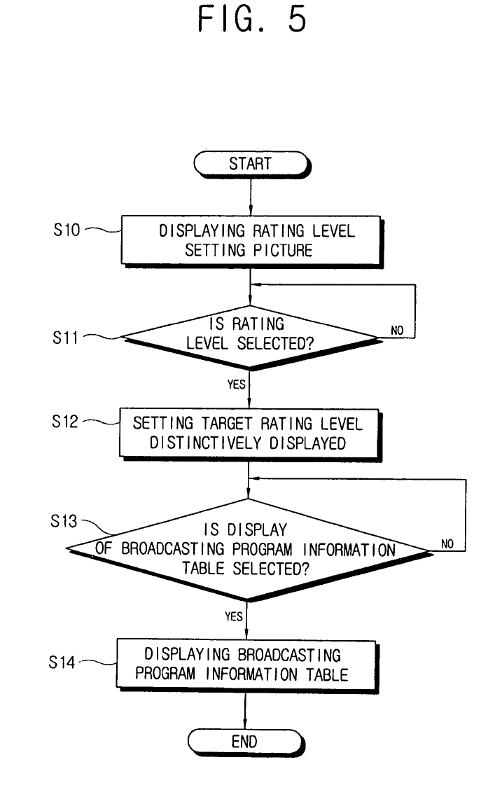

Hereinafter, a process of controlling the broadcasting signal receiving apparatus according to the present invention will be described with reference to FIG. 5.

First, when a user selects the rating level setting picture SUI to be displayed, through the manipulation of the user input part 60, the controller 90 controls the UI generator 70 to display the rating level setting picture SUI on the display part 40 at operation S10.

When a user selects the rating level of the rating level setting picture SUI through the manipulation of the user input part 60 at operation S11, the controller 90 sets the target rating level corresponding to the selected rating level at operation S12.

If a user selects the broadcasting program information table IT to be displayed at operation S13, through the manipulation of the user input part 60 while the target rating level is set, the controller 90 controls the UI generator 70 to display the broadcasting program information table IT on the display part 40 at operation S14. At this time, the information on the target program corresponding to the target rating level is displayed with a different color from that of the information on the remaining broadcasting programs on the broadcasting program information table IT displayed on the display part 40.

The present invention may be applicable to a broadcasting signal receiving apparatus, which receives signals for terrestrial, cable and/or satellite broadcastings. Also, the present invention may be applicable to a broadcasting signal receiving apparatus, which receives an analog broadcasting signal other than the digital broadcasting signal. Further, the present invention may be applicable to other channel functions other than a channel converting function, a channel list displaying function, a displaying function of the broadcasting program guide information.

In the foregoing embodiment, the digital TV is provided as an example of the broadcasting signal receiving apparatus according to the present invention, but not limited thereto. Alternatively, the present invention is applicable to other apparatuses receiving and processing the broadcasting signal such as the set-top box.

Although a few non-limiting embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A broadcasting signal receiving apparatus which receives broadcasting program information and rating level information of broadcasting programs, comprising:
a user input part operative to set a target rating level;
a user interface (UI) generator operative to generate a broadcasting program information table; and
a controller operative to detect a target program, among the broadcasting programs, distinctively displayed corresponding to the target rating level and to control the UI generator to display, on the broadcasting program information table, information on the detected target program with a different color from information on remaining broadcasting programs among the broadcasting programs.

2. The apparatus according to claim 1, wherein the UI generator is operative to generate a rating level setting picture to select at least one of a plurality of rating levels, and
the controller is operative to set at least one rating level selected by the user input part among the plurality of rating levels displayed on the rating level setting picture, as the target rating level.

3. The apparatus according to claim 2, wherein the controller is operative to set the rating level selected from the rating level setting picture and a view-limited rating level according to the selected rating level among the plurality of rating levels, as the target rating level.

4. The apparatus according to claim 2, wherein the broadcasting program information table comprises:
at least one first broadcasting program information block which has a first background color and displays information on the detected target program, and
at least one second broadcasting program information block which has a second background color different from the first background color, and displays information on the remaining broadcasting programs.

5. The apparatus according to claim 4, wherein the controller is operative to control the UI generator to arrange the first broadcasting program information block and the second broadcasting program information block based on at least one of time and channel of the broadcasting program.

6. The apparatus according to claim 5, wherein the rating level information is included in at least one of moving picture experts group (MPEG) user data, a program map table (PMT), an event information table (EIT), an aggregate event information table (AEIT), and vertical blanking interval (VBI) data, to be transmitted.

7. A method of controlling a broadcasting signal receiving apparatus, comprising:
setting a target rating level;
detecting broadcasting program information and rating level information of broadcasting programs;
detecting a target program, among the detected broadcasting programs, which is distinctively displayed corresponding to the target rating level; and
displaying a broadcasting program information table on which information on the detected target program is displayed with a different color from that of information on remaining broadcasting programs among the detected broadcasting programs.

8. The method according to claim 7, wherein setting of the target rating level comprises:
displaying a rating level setting picture to select one of a plurality of rating levels;
selecting one of the plurality of rating levels displayed on the rating level setting picture; and
setting the selected rating level and a view-limited rating level, according to the selected rating level among the plurality of rating levels, as the target rating level.

9. The method according to claim 8, wherein the broadcasting program information table comprises at least one first broadcasting program information block which has a first background color, and displays the information on the detected target program; and
at least one second broadcasting program information block which has a second background color different from the first background color, and displays the information on remaining broadcasting programs.

10. The method according to claim 9, further comprising arranging the first broadcasting program information block and the second broadcasting program information block based on at least one of time and channel of the broadcasting programs.

11. The method according to claim 7, wherein the rating level information is included in at least one of moving picture experts group (MPEG) user data, a program map table (PMT), an event information table (EIT), an aggregate event information table (AEIT) and vertical blanking interval (VBI) data, to be transmitted.
